(19) United States
(12) Patent Application Publication
(10) Pub. No.: US 2025/0290796 A1
(43) Pub. Date: Sep. 18, 2025

(54) Photon Number Resolving Detector

(71) Applicant: PsiQuantum Corp., Palo Alto, CA (US)

(72) Inventors: Koustuban Ravi, Oakland, CA (US); Avishai Benyamini, Palo Alto, CA (US)

(21) Appl. No.: 19/227,030

(22) Filed: Jun. 3, 2025

Related U.S. Application Data
(63) Continuation of application No. PCT/US2023/082999, filed on Dec. 7, 2023.
(60) Provisional application No. 63/431,281, filed on Dec. 8, 2022.

(51) Int. Cl. G01J 1/44

(52) U.S. Cl. CPC G01J 1/44; G01J 2001/442; G01J 2001/448

(57) ABSTRACT

The various embodiments described herein include methods, devices, and systems for detecting photons. As described herein, superconducting photodetectors may be coupled with a waveguide such that reflection is reduced/minimized. In one aspect, an optical circuit includes an optical waveguide and a plurality of photodetectors coupled to the optical waveguide, adjacent photodetectors of the plurality of photodetectors being spaced to meet one or more preset destructive interference criteria.

### PRIORITY AND RELATED APPLICATIONS

This application is a continuation of PCT Patent Application No. PCT/US2023/082999, filed Dec. 7, 2023, which claims priority to U.S. Provisional Patent Application No. 63/431,281, entitled “Photon Number Resolving Detector” filed Dec. 8, 2022, each of which is hereby incorporated by reference in its entirety.

### TECHNICAL FIELD

This relates generally to photon detectors including but not limited to, superconducting photon detectors.

### BACKGROUND

Photon detectors (also sometimes called ‘photodetectors’) are components that can be implemented in electronic devices. Ultra-sensitive photon detectors that are capable of detecting a small number of photons, such as individual photons (e.g., single photons), are used in a variety of applications, such as optical communications, medical diagnostics, and space research. One such use of ultra-sensitive photon detectors is for optical quantum information applications. Superconductors are materials capable of operating in a resistive non-superconducting state, and also in a superconducting state with zero electrical resistance under particular conditions.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 is a diagram illustrating an example circuit that includes a waveguide coupled to photodetectors in accordance with some embodiments.

FIGS. 2A-2C are diagrams illustrating example waveguides coupled to example photodetectors in accordance with some embodiments.

FIG. 3 illustrates a cross-sectional view of an example waveguide and photodetector in accordance with some embodiments.

FIG. 4A illustrates a waveguide with a Bragg mirror in accordance with some embodiments.

FIG. 4B illustrates a waveguide with a loop mirror in accordance with some embodiments.

FIG. 5 is a circuit diagram illustrating operation of a photon counting device in accordance with some embodiments.

FIG. 6 shows a flow diagram of a method for implementing a photon counting device in accordance with some embodiments.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Many modifications and variations of this disclosure can be made without departing from its spirit and scope, as will be apparent to those skilled in the art. The specific embodiments described herein are offered by way of example only, and the disclosure is to be limited only by the terms of the appended claims, along with the full scope of equivalents to which such claims are entitled.

Photon number resolving detectors (also sometimes called photon counting devices) can be implemented to detect quantum light (e.g., single photons) in a photonic quantum device (e.g., quantum circuit, quantum computer). In some photonic quantum devices, the probability of detection by any one of the photon detectors is in given range to generate desired results (e.g., quantum measurements, output data, error correction data). In some example embodiments, an array of photon detectors in a photonic quantum device are configured to maximize total absorption and minimize reflection to increase operating efficiency and decrease optical loss, which can degrade quantum light detection and information processing. In some example embodiments, a width of a waveguide is varied (e.g., tapered) to adjust absorption and reflection rates. Further, in some example embodiments, the spacing between photon detectors, the dimensions of the photon detectors, and/or the spacing between the photon detectors and the waveguide in the photonic device are configured to optimize absorption and reflection rates.

In some example embodiments, each photon detector is configured with specific absorption values to obtain a probability distribution for quantum light (e.g., single photons) for a given application. Further, in a given detector of the device, a waveguide width is configured to implement adiabatic tuning between adjacent detectors in the photonic device. The spacing between photon detectors may be configured such that destructive interference of reflected amplitudes occurs within the waveguide. In some embodiments, the modal index varies along the propagation direction and thus the spacing between detectors is non-uniform to satisfy the destructive interference condition.

In one aspect, some embodiments include an optical circuit that comprise an optical waveguide and a plurality of photodetectors coupled to the optical waveguide, adjacent photodetectors of the plurality of photodetectors being spaced to meet one or more preset destructive interference criteria.

Thus, devices and circuits are provided with methods for fabricating and operating photodetector circuitry, thereby increasing the effectiveness, efficiency, and user satisfaction with such circuits and devices.

The present disclosure describes photon number resolving systems and components. As light passes through a photon number resolving system, the absorption of each photon detector depends on an absorption probability and an efficiency of the photon detector. Efficiency can be improved by reducing reflections between the photon detectors and waveguides. Some embodiments include arranging the photon detectors along a waveguide to reduce reflections and/or increase destructive interference. For example, arranging the photon detectors to have specific spacing between one another. As another example, the photon detectors are arranged to have specific spacing from the waveguide(s). Some embodiments include sizing the photon detectors to reduce reflections and/or increase destructive interference. Some embodiments include adjusting a width of the waveguide at each photon detector to reduce reflections and/or increase destructive interference.

Issues can occur when there are multiple wires (e.g., nanowires and/or photon detectors) crossing a waveguide as there is a potential for reflections from each wire. In some example embodiments, reflections can be reduced by using a half-wave plate and/or by using anti-reflective coatings. In some example embodiments, an integral relation, such as Equation 1 below, is solved to determine spacings between each of the nanowires such that reflections from the separate nanowires cancel each other and thereby reduce overall reflection and increase optical efficiency.

In some example embodiments, Equation 1 is selected so that the phase difference (for a given wavelength of light) is 180 degrees (Pi) and phase cancellation occurs between adjacent detectors. For example, the adjacent detectors can function as reflection faces as in an etalon or Fabry-Pérot interferometer. At a high level of generality, and with reference to Equation 1 below, given zk, zk+1 is the location of the next nearest detector (e.g., nanowire) to be placed, which is to be determined by solving Equation 1.

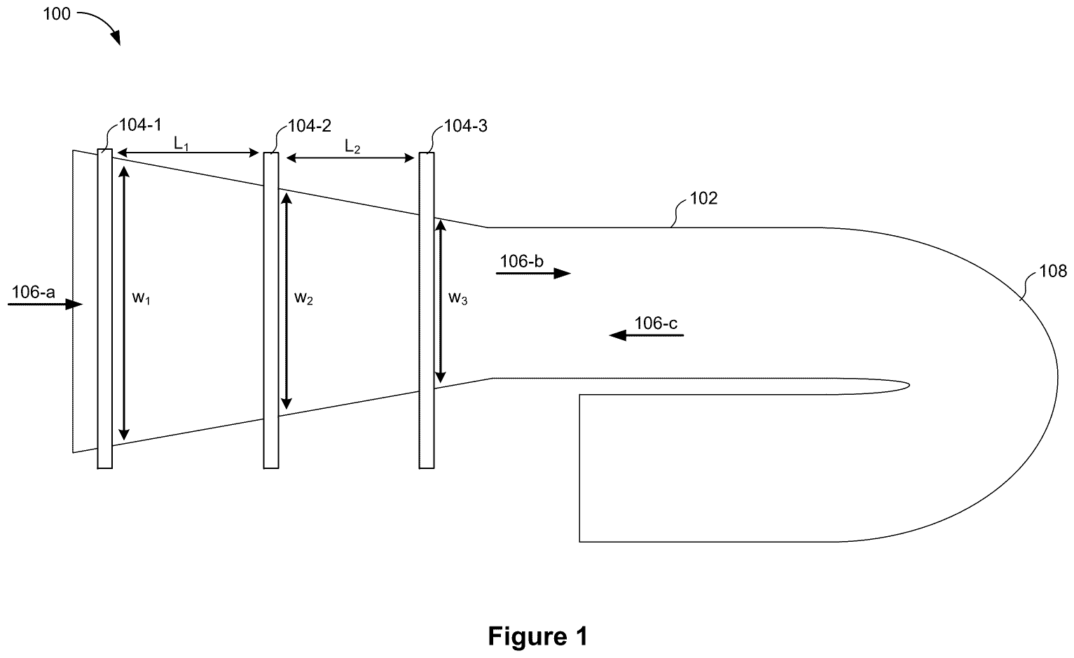

In some example embodiments, the absorption coefficient is set by the width of the taper of the waveguide (e.g., w1 of the waveguide 108 in FIG. 1) at the location of a given nanowire (e.g., the detector 104-1). In some example embodiments, the width of the taper at each nanowire is determined through testing different design widths (e.g., in simulation or physically building different models) and determining which taper width for each nanowire intersection exhibit the best performance (e.g., the least optical loss).

FIG. 1 is a diagram illustrating a circuit 100 that includes a waveguide 102 coupled to photodetectors 104 in accordance with some embodiments. The photodetectors 104 in FIG. 1 have a same width (also sometimes referred to as a diameter) and are arranged over the waveguide 102 with varying distance between adjacent photodetectors. For example, the photodetector 104-1 in FIG. 1 is separated from the photodetector 104-2 by a distance labeled L₁ and the photodetector 104-2 is separated from the photodetector 104-3 by a distance labeled L₂. In the example of FIG. 1, the waveguide 102 has a different width at each of the photodetectors 104. For example, the waveguide 102 has a width of w₁ at the photodetector 104-1, a width of w₂ at the photodetector 104-2, and a width of w₃ at the photodetector 104-3. In some embodiments, the photodetectors are spaced such that reflections between adjacent photodetectors have a phase difference of pi (π).

In some embodiments, the waveguide 104 has a tapered shape configured to reduce (minimize) current crowding effects. Geometric shapes, such as bends, corners, and splits, in a superconducting circuit can result in current crowding effects if not constructed appropriately. The current crowding effects can cause the superconducting circuit to operate a non-superconducting state, which may result in operational failures and erroneous results. In some embodiments, if the ratio of w₁ to w₃ is less than a preset factor (e.g., 3, 4, or 5, or more generally a predefined value between 2.5 and 5), the waveguide 102 has a tapered shape meeting one or more current crowding reduction criteria (e.g., mathematically-optimal tapered shape). In some embodiments, if the ratio of w₁ to w₃ is greater than the preset factor, the waveguide 102 includes a series of tapers or a tapered shape that is elongated from a mathematically-optimal taper. In some embodiments, each taper is a tapered region of superconducting material having two ends, each end of the tapered region having a distinct width. In some embodiments, the tapers of waveguide 102 are shaped so as to reduce current crowding within the waveguide 102. In some embodiments, the tapers of waveguide 102 are adapted (e.g., designed) based on a lithography process used to form the connector. In some embodiments, the waveguide 102 includes multiple tapered regions and the tapered regions have respective first derivatives that are matched at connection points of the tapered regions.

In accordance with some embodiments, the waveguide 102 further includes a loop mirror 108. The loop mirror 108 is configured to so that light guided by the waveguide 102 that is incident upon (e.g., received by) the loop mirror 108 is reflected back into the waveguide 102 allowing light to be propagated past the photodetectors 104 at least twice. For example, light 106 propagates through the waveguide 102 from a position of 106-a to a position of 106-b (e.g., is not detected by any of the photodetectors 104) and is reflected back by the loop mirror 108 to position 106-c.

In some embodiments, the photodetectors 104 are positioned along the waveguide 102 such that reflections between adjacent photodetectors cancel out (e.g., destruction interference). In some embodiments, the photodetectors 104 are arranged such that the wavelength of reflections between adjacent photodetectors are offset by π. In some embodiments, the photodetectors 104 are positioned in an aperiodic grating structure. In some embodiments, the spacing between photodetectors is different in order to meet the condition of destructive interference between reflected amplitudes. In some embodiments, the relationship between the photodetectors 104 and the waveguide 102 is governed by:

$$\text{Anti-reflection} condition$$

$${\int }_{{z}_{k}}^{{z}_{k + 1}} n ( z ) d z = \frac{{λ}_{0}}{4} - {n}_{k} {d}_{k} \qquad Equation 1$$

where k corresponds to the k^{th} photodetector and k+1 corresponds to the photodetector adjacent to the k^{th} photodetector. In Equation 1, n(z) is the region of overlap between the photodetector and the waveguide, nₖ is the modal index of the region of overlap, and dₖ is the width of the k^{th} photodetector. In some embodiments, the modal index is based on a material (e.g., doping level) of the waveguide and/or a material of the photodetector.

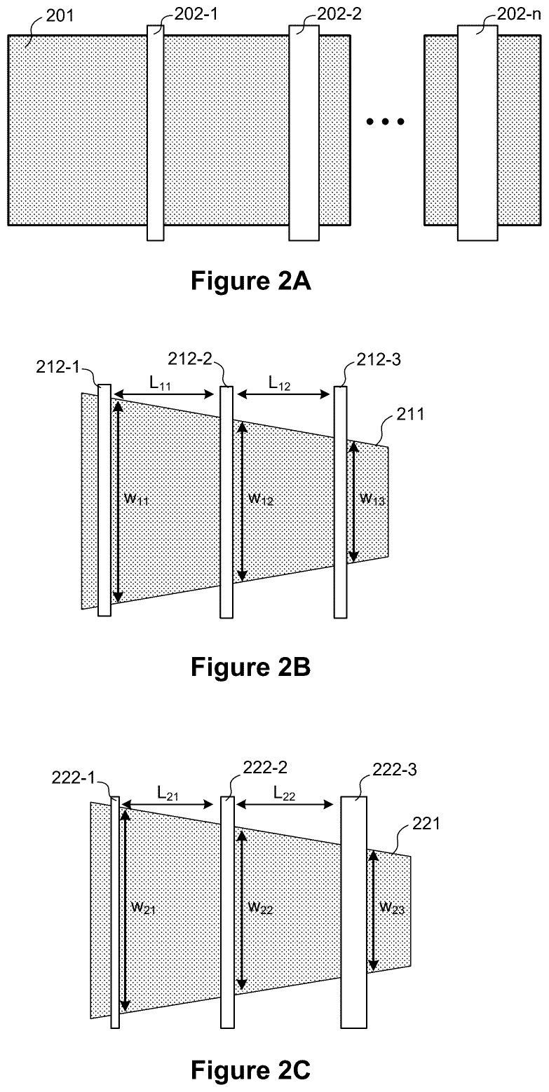

FIGS. 2A-2C are diagrams illustrating example waveguides coupled to example photodetectors in accordance with some embodiments. FIG. 2A shows a waveguide 201 with a plurality of photodetectors 202 in accordance with some embodiments. In FIG. 2A, the photodetectors 202 have varying widths. For example, the photodetector 202-2 has a larger width than the photodetector 202-1 and the photodetector 202-n has a larger width than the photodetector 202-2. In some embodiments, the respective widths of the photodetectors 202 are determined using Equation 1.

FIG. 2B shows a waveguide 211 with a plurality of photodetectors 212 in accordance with some embodiments. In FIG. 2B, the photodetectors 212 have a same width, but are spaced at different distances along the waveguide 211. For example, the photodetector 212-1 is a distance of L₁₁ from the photodetector 212-2 and the photodetector 212-3 is a distance of L₁₂ from the photodetector 212-2. In the example of FIG. 2B, the waveguide 211 has a different width at each photodetector (e.g., has a tapered shape). For example, the waveguide 211 has a width of w₁₁ at the photodetector 212-1, a width of w₁₂ at the photodetector 212-2, and a width of w₁₃ at the photodetector 212-3. In some embodiments, the respective distances between the photodetectors 212 are determined using Equation 1.

FIG. 2C shows a waveguide 221 with a plurality of photodetectors 222 in accordance with some embodiments. In FIG. 2C, the photodetectors 222 have different widths and are spaced at different distances along the waveguide 221. For example, the photodetector 222-1 is a distance of L₂₁ from the photodetector 222-2 and the photodetector 222-3 is a distance of L₂₂ from the photodetector 222-2. Also, the photodetector 222-2 has a larger width than the photodetector 222-1 and the photodetector 222-3 has a larger width than the photodetector 222-2. In the example of FIG. 2C, the waveguide 221 has a different width at each photodetector (e.g., has a tapered shape). For example, the waveguide 221 has a width of w₂₁ at the photodetector 222-1, a width of w₂₂ at the photodetector 222-2, and a width of w₂₃ at the photodetector 222-3. In some embodiments, the respective distances between the photodetectors 222 and the respective widths of the photodetectors 222 are determined using Equation 1.

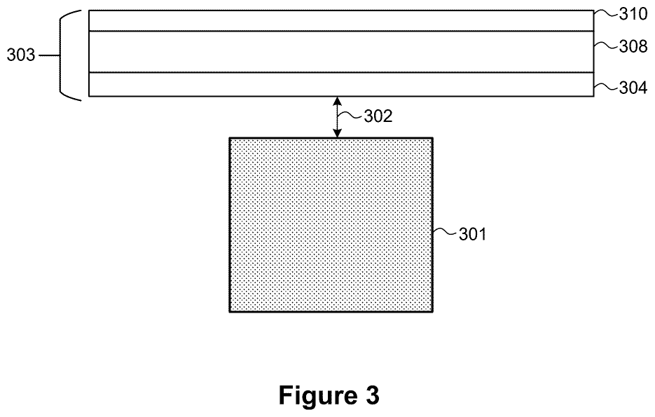

FIG. 3 illustrates a cross-sectional view of a waveguide 301 and a photodetector 303 in accordance with some embodiments. In some embodiments, the waveguide 301 is composed of silicon. In some embodiments, the waveguide 301 is separated from the photodetector 303 by a distance 302 (e.g., a gap). In some embodiments, the distance 302 is composed of a dielectric material (e.g., an oxide). In some embodiments, the waveguide 301 is an instance of any of the waveguides described herein (e.g., the waveguide 102, 201, 211, or 221). In some embodiments, the photodetector 303 is an instance of any of the photodetectors described herein (e.g., the photodetectors 104, 202, 212, or 222).

In some embodiments, the photodetectors described herein (e.g., the photodetectors 104, 202, 212, 222, and 303) have non-uniform absorption rates. In some embodiments, the photodetectors described herein are arranged to maximize absorption and minimize reflection (e.g., in accordance with Equation 1), within a predefined margin of error. In some embodiments, the photodetectors described herein are composed of superconducting material. For example, each photodetector may include a superconducting wire.

In the example of FIG. 3, the photodetector 303 includes multiple layers (e.g., layers 304, 308, and 310). In some embodiments, the layer 308 is composed of niobium (e.g., niobium nitride), iron (e.g., iron pnictide), vanadium (e.g., vanadium silicide), copper oxide (e.g., LB-CO), and/or magnesium (e.g., magnesium diboride). In some embodiments, the layer 308 has a thickness in the range of 0.2 nanometers to 200 nanometers. In some embodiments, the layer 304 is a non-superconductive layer (e.g., a dielectric layer, a conductive layer, and/or composed of other non-superconductive materials). In some embodiments, the layer 304 is composed of silicon (e.g., silicon nitride or silicon dioxide) and/or aluminum (e.g., aluminum nitride). In some embodiments, the layer 304 has a thickness in the range of 0.2 nanometers to 200 nanometers. In some embodiments, the layer 310 is composed of silicon (e.g., amorphous silicon) and/or aluminum (e.g., aluminum nitride). In some embodiments, the layer 310 has a thickness in the range of 0.2 nanometers to 200 nanometers. In some embodiments, the photodetector 303 includes more or less layers than shown in FIG. 3 (e.g., only includes the layer 308).

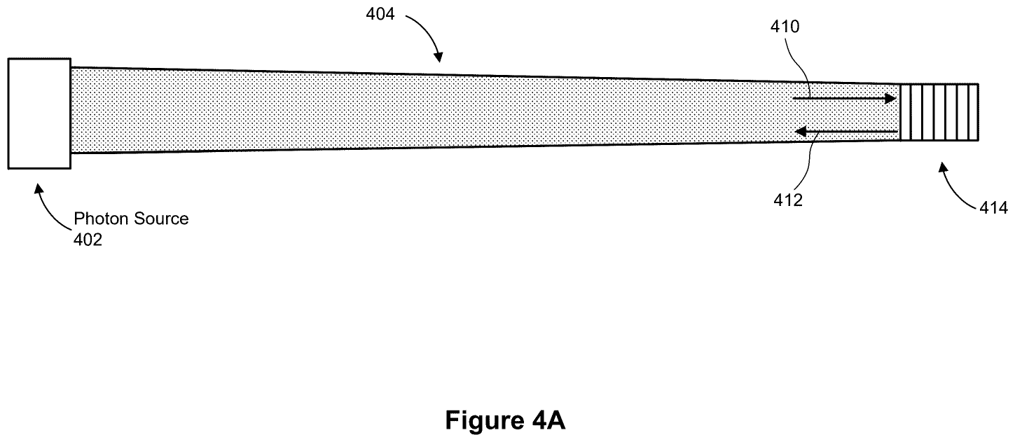

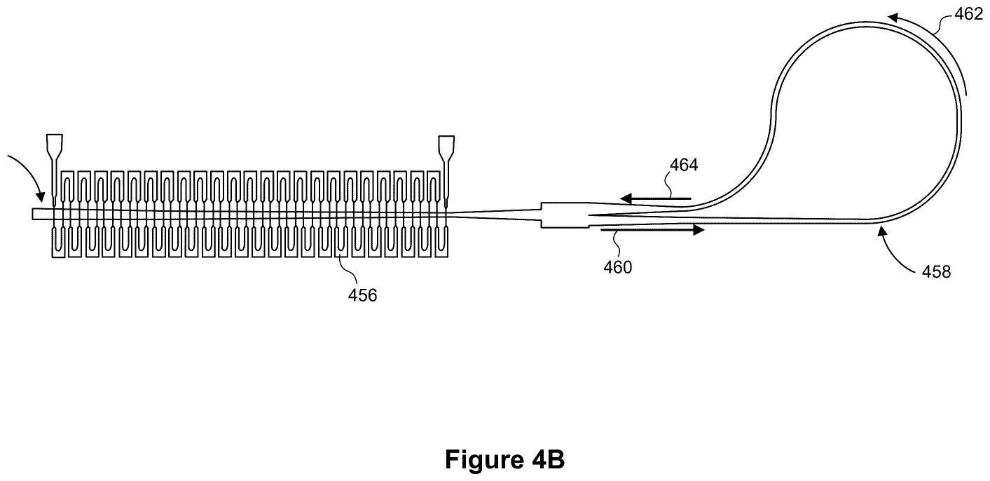

FIG. 4A illustrates a waveguide 404 with a Bragg mirror 414 in accordance with some embodiments. The Bragg mirror 414 (e.g., a distributed Bragg reflector) is a reflective element (e.g., a reflector) that includes a plurality of layers with different (e.g., alternating) refractive indices. The Bragg mirror 414 is configured to be coupled (e.g., optically coupled) to the waveguide 404 so that any light guided by the waveguide 404 that is incident upon the Bragg mirror 414 is reflected back into the waveguide 404, allowing the reflected light to be propagated past a photodetector at least twice. For example, as shown in FIG. 4A, a first portion of the tapered waveguide 404 is coupled (e.g., optically coupled, directly or indirectly) to a photon source 402 and a second portion of the tapered waveguide 404 is coupled (e.g., optically coupled, directly or indirectly) to the Bragg mirror 414 such that light output from the photon source 402 and guided through the waveguide 404 is reflected at the Bragg mirror 414 back into the waveguide 404 and guided by the waveguide 404 back toward the photon source 402. In the example of FIG. 4A, the arrow 410 represents a propagation direction of light in the waveguide 404, and the arrow 412 represents a propagation direction of light in the waveguide 404 after being reflected by the Bragg mirror 414.

FIG. 4B illustrates a waveguide 452 with a loop mirror 458 in accordance with some embodiments. The loop mirror 458 is a waveguide (e.g., optical waveguide, optical fiber) that is coupled (e.g., optically coupled, coupled via a splitter) to the waveguide 452 such that light is guided from the waveguide 452 into the loop mirror 458 and the light is guided by the waveguide of the loop mirror 458 back into the waveguide 452. The loop mirror 458 is configured to be coupled (e.g., optically coupled) to the waveguide 452 so that any light guided by the waveguide 452 that is incident upon (e.g., received by) the loop mirror 458 is reflected back into the waveguide 452, allowing light to be propagated past a set of photodetectors 456 at least twice. For example, as shown in FIG. 4B, a portion of the tapered waveguide 452 is coupled (e.g., optically coupled, directly or indirectly) to the loop mirror 458 such that light guided through the waveguide 452 is guided by the loop mirror 458 back into the waveguide 452 and is guided by the waveguide 452 back toward a photon source. In the example of FIG. 4B, the arrow 460 illustrates propagation of light from the waveguide 452 into the loop mirror 458; the arrow 462 illustrates a propagation direction of light in the loop mirror 458; and the arrow 464 illustrates propagation of light from the loop mirror 458 into the waveguide 452.

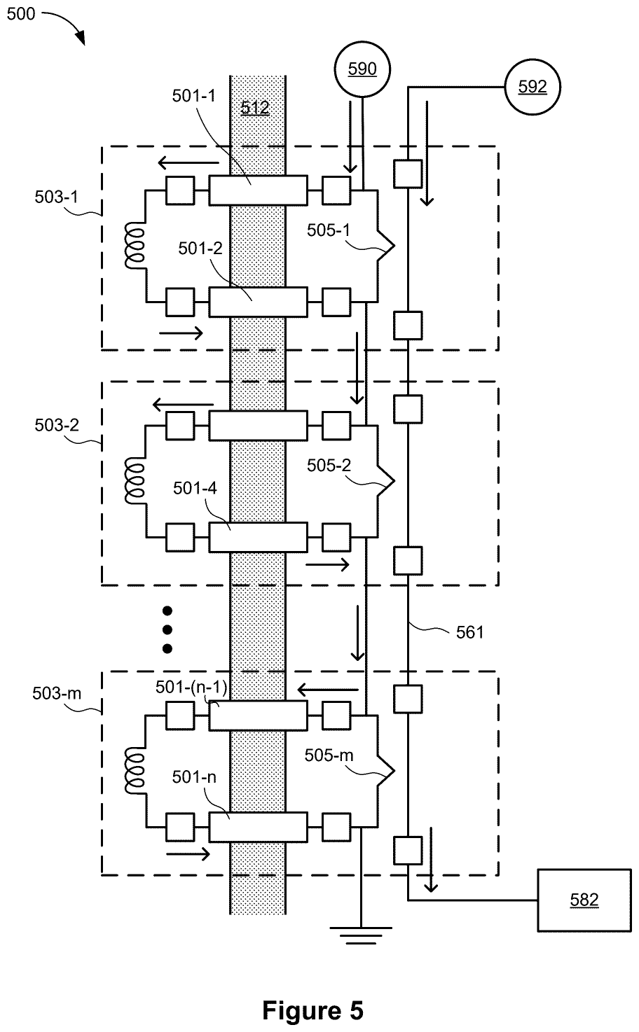

FIG. 5 is a circuit diagram illustrating operation of a photon counting device 500 (e.g., a circuit) in accordance with some embodiments. The photon counting device 500 includes a set of photodetectors 503 (photodetectors 503-1 through 503-m) coupled to a waveguide 512. Operation of the photon counting device 500 includes maintaining superconducting components 501 (superconducting components 501-1 through 501-n) of the photodetectors 503 at a temperature that is below the threshold temperature of the superconducting components 501 of the photodetectors, and maintaining superconducting gates 505 at a temperature that is below the threshold temperature of the superconducting gates 505. The superconducting components 501-1 of the photodetectors 503 are biased (e.g., by a bias current source 590) below a current threshold of the superconducting components 501 of the photodetectors 503 such that an increase in current in a superconducting component (e.g., due to absorption of a photon) causes the superconducting component to exceed the current threshold of the superconducting component and transition from the superconducting state to the non-superconducting state.

The superconducting gate 505-1 is configured to be in the non-superconducting state while the one or more photodetectors 503 (e.g., superconducting components 501) are in the non-superconducting state. The superconducting gate 505 is configured to transition from the non-superconducting state to the superconducting state in response to at least one of the photodetectors of the one or more photodetectors 503 (e.g., superconducting components 501 of the photodetectors 503) transitioning from the non-superconducting state to the superconducting state. In some embodiments, the superconducting gates 505 are configured to transition from the non-superconducting state to the superconducting state when all of the superconducting components 501 that were in the non-superconducting state transition to the superconducting state.

The photodetectors 503 are coupled to a readout line 561. In the example of FIG. 5, the readout line 561 is coupled to an electrical source 592 (e.g., a current or voltage source) and a readout circuit 582. Changes to the resistance of the readout line 561, for example due to a change in resistance of the superconducting gates 505 are reflected in either a detection current or a voltage of the detecting current signal at the readout circuit 582.

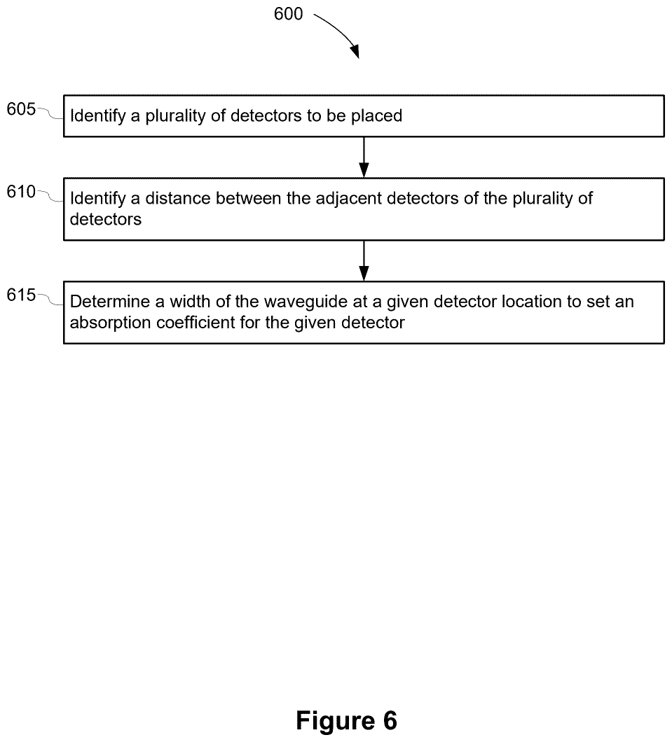

FIG. 6 shows a flow diagram of a method 600 for implementing (e.g., fabricating) a photon counting device in accordance with some embodiments.

At operation 605, a plurality of detectors to be placed are identified. In some embodiments, the plurality of detectors are to be placed adjacent to a waveguide (e.g., arranged so that photons can transfer between the waveguide and the detectors). For example, at operation 605, the detectors 104-1 and 104-2 are identified.

At operation 610, the distances between adjacent detectors of the plurality of detectors identified at operation 605 are determined such that cancelation occurs in the waveguide between the detectors. For example, at operation 610, L1 in FIG. 1 is determined by solving Equation 1 for the detector 104-1 and the detector 104-2. In some example embodiments, additional detectors are to be included in the photon counting device (e.g., the detector 104-3) and operations 605 and 610 are repeated to determine additional placement parameters (e.g., the distance L2) and so on.

At operation 615, a width of the waveguide (e.g., the waveguide 108) is determined at respective locations for the plurality of detectors, e.g., to set respective absorption coefficients for the plurality of detectors. For example, at operation 615, the values of the widths w1, w2, w3 are set such that the respective absorption coefficient for each detector 104-1, 104-2, and 104-3 is kept below an absorption probability, p0, as discussed above. In some example embodiments, the values of the widths that yield absorption probabilities below the absorption probability p0 are determined through testing of different taper angles of the taper of the waveguide 108 to determine which taper angle yields widths that result in the designed absorption probability below p0.

In light of these principles, we now turn to certain embodiments.

(A1) In accordance with some embodiments, an optical circuit (e.g., the circuit 100) includes: an optical waveguide (e.g., the waveguide 102); and a plurality of photodetectors (e.g., the photodetectors 104) coupled to the optical waveguide, adjacent photodetectors of the plurality of photodetectors being spaced to meet one or more preset destructive interference criteria (e.g., minimize reflections). In some embodiments, the plurality of photodetectors includes a plurality of nanowires. For example, each photodetector includes a respective superconducting wire. In some embodiments, the photodetectors are configured to detect light (photons) from the optical waveguide. In some embodiments, an absorption coefficient is assigned to each photodetector (e.g., based on a desired operability of the optical circuit). In some embodiments, after the absorption coefficients are assigned, a waveguide width is assigned for each photodetector location (e.g., a tapered shape is defined for the waveguide). In some embodiments, after the waveguide widths are assigned, a photodetector width is assigned for each photodetector. In some embodiments, the waveguide width and/or photodetector width for each photodetector location are determined based on the absorption coefficient for the photodetector at each photodetector location.

(A2) In some embodiments of A1, each photodetector of the plurality of photodetectors comprises a respective superconducting wire. In some embodiments, each photodetector includes a superconducting material (e.g., niobium). In some embodiments, each photodetector includes a layer of superconducting material (e.g., the layer 308) and one or more layers of non-superconducting material (e.g., the layers 304 and 310).

(A3) In some embodiments of A1 or A2, the optical waveguide has a respective width at each superconducting wire of the plurality of superconducting wires that meets the one or more preset destructive interference criteria. In some embodiments, the optical waveguide has a tapered shape (e.g., to minimize current-crowding effects). In some embodiments, the optical waveguide is assigned a respective width at each photodetector in accordance with Equation 1. In some embodiments, the combination of waveguide width and wire spacing meets the preset criteria (e.g., the criteria of Equation 1). In some embodiments, the optical waveguide is composed of silicon.

(A4) In some embodiments of any of A1-A3, the one or more preset destructive interference criteria include a criterion to reduce (e.g., minimize) reflections between the plurality of superconducting wires and the optical waveguide. For example, a first optical circuit has a plurality of photodetectors that are evenly spaced and has a reflection value of a; and a second optical circuit has a plurality of photodetectors that are spaced in accordance with Equation 1 above and has a reflection value of B, where β is less than a. In some embodiments, the one or more preset destructive interference criteria include a criterion that adjacent photodetectors have reflections with a phase difference of pi.

(A5) In some embodiments of any of A1-A4, the optical waveguide has a respective width at each photodetector of the plurality of photodetectors that meets a corresponding preset absorption probability (e.g., 1%, 10%, or 25%). For example, the width of the optical waveguide at each photodetector is assigned to achieve a particular absorption probability. In some embodiments, the width of the optical waveguide (e.g., the tapered shape) is assigned to achieve a particular absorption probability. In some embodiments, after the width of the optical waveguide is assigned, a width of each photodetector is assigned to reduce/minimize reflections. In some embodiments, after the width of the optical waveguide is assigned, spacing for the photodetectors is assigned to reduce/minimize reflections.

(A6) In some embodiments of any of A1-A5, the one or more preset destructive interference criteria include a criterion that is based on a modal index (e.g., a refractive index) of an overlap region of the optical waveguide and respective photodetectors of the plurality of photodetectors. For example, the one or more preset destructive interference criteria include a width of each photodetector in accordance with Equation 1.

(A7) In some embodiments of any of A1-A6, each photodetector of the plurality of photodetectors is sized (e.g., has a respective width) to meet the one or more preset destructive interference criteria. For example, a combination of sizing and spacing of the photodetectors meets the preset criteria.

(A8) In some embodiments of any of A1-A7, each photodetector of the plurality of photodetectors is separated from the optical waveguide by a respective distance (e.g., the distance 302) that meets the one or more preset destructive interference criteria. In some embodiments, the respective distance is assigned to achieve a preset absorption probability. In some embodiments, the respective distance is based on the preset absorption probability and one or more fabrication requirements (e.g., a particular fabrication process requires that the respective distance be within a particular range).

(A9) In some embodiments of any of A1-A8, the optical waveguide is tapered in accordance with the one or more preset destructive interference criteria. For example, the waveguide has an adiabatic tapered shape. In some embodiments, the optical waveguide is shaped in accordance with one or more of: the one or more preset destructive interference criteria, current crowding effects, and a target absorption probability for a given detector design. In some embodiments, sizing and/or spacing of the photodetectors is assigned based on a shape of the waveguide (e.g., a width of the waveguide at each of the photodetectors).

(A10) In some embodiments of any of A1-A9, the optical waveguide is composed of silicon (e.g., silicon and/or nitrogen). In some embodiments, plurality of photodetectors are composed of a superconducting material (e.g., niobium).

(A11) In some embodiments of any of A1-A10, spacing between the plurality of photodetectors is non-uniform. For example, FIG. 1 shows a spacing of L₁ between the photodetectors 104-1 and 104-2 and a spacing of L₂, different than L₁, between the photodetectors 104-2 and 104-3.

(A12) In some embodiments of any of A1-A11, respective photodetectors of the plurality of photodetectors have different widths (e.g., different diameters). For example, FIG. 2A shows the photodetectors 202 having varying widths (e.g., the width of photodetector 202-1 is less than the width of photodetector 202-2).

(A13) In some embodiments of any of A1-A12, the plurality of photodetectors are vertically stacked with the optical waveguide. For example, the optical waveguide is on a first layer and the plurality of photodetectors are on a second layer that is arranged above or below the first layer. In some embodiments, the optical waveguide is positioned on a same layer as the plurality of superconducting wires.

(A14) In some embodiments of any of A1-A13, the optical waveguide includes a reflector component (e.g., a loop mirror or Bragg mirror) configured to back propagate light through the optical waveguide. For example, FIG. 4A shows a waveguide with a Bragg mirror component and FIG. 4B shows a waveguide with a loop mirror component.

(A15) In some embodiments of any of A1-A14, the optical circuit further includes a plurality of readout circuits electrically coupled to respective photodetectors of the plurality of photodetectors, each readout circuit of the plurality of readout circuits configured to measure an electrical property of the respective photodetector, where the electrical property is indicative of a number of photons incident to the respective photodetector. In some embodiments, the optical circuit includes a readout component (e.g., the readout circuit 582) coupled to one or more of the photodetectors.

(A16) In some embodiments of any of A1-A15, the optical circuit further includes one or more current sources (e.g., the bias current source 590 and/or the electrical source 592) electrically coupled to the plurality of photodetectors and configured to supply the plurality of photodetectors with electrical current.

As used herein, a “superconducting component” or “superconductor component” is a component having one or more superconducting materials. For example, a superconducting photodetector circuit is a photodetector circuit that includes one or more superconducting materials. As used herein, a “superconducting” material is a material that is capable of operating in a superconducting state (under particular conditions). For example, a material that operates as a superconductor (e.g., operates with zero electrical resistance) when cooled below a particular temperature (e.g., a critical temperature) and having less than a threshold current flowing through it. A superconducting material is also called a superconduction-capable material. In some embodiments, the superconducting materials operate in a non-superconducting state during which the materials have a non-zero electrical resistance (e.g., a resistance in the range of one thousand to ten thousand ohms). For example, a superconducting material supplied with a current greater than a threshold superconducting current for the superconducting material may transition from a superconducting state with zero electrical resistance to a non-superconducting state with non-zero electrical resistance. As an example, superconducting component 210 of photodetector 120 is a superconducting material that is capable of operating in a superconducting state (e.g., under particular operating conditions).

As used herein, a “wire” is a section of material configured for transferring electrical current. In some embodiments, a wire includes a section of material conditionally capable of transferring electrical current (e.g., a wire made of a superconducting material that is capable of transferring electrical current while the wire is maintained at a temperature below a critical temperature). A cross-section of a wire (e.g., a cross-section that is perpendicular to a length of the wire) optionally has a geometric (e.g., flat or round) shape or an irregular (also sometimes called a non-geometric) shape. In some embodiments, a length of a wire is greater than a width or a thickness of the wire (e.g., the length of a wire is at least 5, 6, 7, 8, 9, or 10 times greater than the width and the thickness of the wire).

It will also be understood that, although the terms first, second, etc. are, in some instances, used herein to describe various elements, these elements should not be limited by these terms. These terms are only used to distinguish one element from another. For example, a first layer could be termed a second layer, and, similarly, a second layer could be termed a first layer, without departing from the scope of the various described embodiments. The first layer and the second layer are both layers, but they are not the same layer unless explicitly stated as such.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. An optical circuit, comprising:
an optical waveguide; and
a plurality of photodetectors coupled to the optical waveguide, adjacent photodetectors of the plurality of photodetectors being spaced to meet one or more preset destructive interference criteria.

2. The optical circuit of claim 1, wherein each photodetector of the plurality of photodetectors comprises a respective superconducting wire.

3. The optical circuit of claim 1, wherein the optical waveguide has a respective width at each superconducting wire of the plurality of superconducting wires that meets the one or more preset destructive interference criteria.

4. The optical circuit of claim 1, wherein the one or more preset destructive interference criteria include a criterion to reduce reflections between the plurality of superconducting wires and the optical waveguide.

5. The optical circuit of claim 1, wherein the optical waveguide has a respective width at each photodetector of the plurality of photodetectors that meets a corresponding preset absorption probability.

6. The optical circuit of claim 1, wherein the one or more preset destructive interference criteria include a criterion that is based on a modal index of an overlap region of the optical waveguide and respective photodetectors of the plurality of photodetectors.

7. The optical circuit of claim 1, wherein each photodetector of the plurality of photodetectors is sized to meet the one or more preset destructive interference criteria.

8. The optical circuit of claim 1, wherein each wire of the plurality of photodetectors is separated from the optical waveguide by a respective distance that meets the one or more preset destructive interference criteria.

9. The optical circuit of claim 1, wherein the optical waveguide is tapered in accordance with the one or more preset destructive interference criteria.

10. The optical circuit of claim 1, wherein the optical waveguide is composed of silicon.

11. The optical circuit of claim 1, wherein spacing between the plurality of photodetectors is non-uniform.

12. The optical circuit of claim 1, wherein respective photodetectors of the plurality of photodetectors have different widths.

13. The optical circuit of claim 1, wherein the plurality of photodetectors are vertically stacked with the optical waveguide.

14. The optical circuit of claim 1, wherein the optical waveguide comprises a reflector component configured to back propagate light through the optical waveguide.

15. The optical circuit of claim 1, further comprising a plurality of readout circuits electrically coupled to respective photodetectors of the plurality of photodetectors, each readout circuit of the plurality of readout circuits configured to measure an electrical property of the respective photodetector, wherein the electrical property is indicative of a number of photons incident to the respective photodetector.

16. The optical circuit of claim 1, further comprising one or more current sources electrically coupled to the plurality of photodetectors and configured to supply the plurality of photodetectors with electrical current.
